(19) United States
(12) Patent Application Publication
(10) Pub. No.: US 2021/0334938 A1
(43) Pub. Date: Oct. 28, 2021

(54) IMAGE PROCESSING LEARNING PROGRAM, IMAGE PROCESSING PROGRAM, INFORMATION PROCESSING APPARATUS, AND IMAGE PROCESSING SYSTEM

(71) Applicant: NAVIER INC., Tokyo (JP)

(72) Inventor: Shunta MAEDA, Tokyo (JP)

(21) Appl. No.: 17/371,112

(22) Filed: Jul. 9, 2021

Related U.S. Application Data
(63) Continuation of application No. PCT/JP2020/004451, filed on Feb. 6, 2020.

(30) Foreign Application Priority Data
Mar. 14, 2019 (JP) 2019-047434

(51) Int. Cl. G06T 3/40; G06K 9/62; G06N 20/00

(52) U.S. Cl. CPC G06T 3/4053; G06T 3/4046; G06K 9/6256; H04L 67/10; G06K 9/6218; G06N 20/00; G06K 9/6267

(57) ABSTRACT

A non-transitory computer-readable medium having stored thereon instructions, that when executed by a processor causes a processor to process the following steps (S-1)-(S-8): (S-1) preparing a plurality of target images; (S-2) prepare a plurality of training images; (S-3) for each of the plurality of training images, train and update a first super-resolution model; (S-4) training and update a second super-resolution model; (S-5) labeling and classify each of the plurality of training images according to each label representing a preference of updated super-resolution models; (S-6) using each of the plurality of training images that are clustered in a largest cluster, train and update a super-resolution model-K, wherein K is an arbitrary number in a sequence; (S-7) updating the labels and re-classify the training images in the largest cluster into sub-clusters based on a preference of super-resolution models; and (S-8) repeating (S-6)-(S-7) to generate sub-clusters until a predetermined condition is satisfied.

### CROSS-REFERENCE TO RELATED APPLICATIONS

The present application is a bypass continuation application based on and claims the benefit of priority from the prior Japanese patent application No. 2019-047434 filed on Mar. 14, 2019, and PCT Application No. PCT/JP2020/004451 filed Feb. 6, 2020, the entire contents of which are incorporated herein by reference.

### TECHNICAL FIELD

The embodiments relate to an image processing learning program, an image processing program, an information processing apparatus, and an image processing system.

### BACKGROUND ART

As a conventional technique, there has been proposed an image processing learning program for clustering a data set beforehand and performing learning of super resolution (see, for example, Non Patent Literature 1).

In single image super resolution for restoring a single high-resolution image from a single low-resolution image, the image processing learning program disclosed in Non Patent Literature 1 prepares a plurality of low-resolution images as a data set, clusters the data set beforehand with k-means clustering to divide the data set into classification domains, and prepares a convolutional neural network (CNN) models as many as the number of classification domains and performs learning using the distance between an image input to the CNN models and a cluster center to obtain super-resolution models. The image processing learning program performs, about the trained CNN models, which are the super-resolution models, inference using the distance between the input image and the cluster center.

### CITATION LIST

### Non Patent Literature

Non Patent Literature 1: Zhen Li, other five people, “Clustering based multiple branches deep networks for single image super-resolution”, Multimedia Tools and Applications, Springer Science+Business Media, Dec. 14, 2018

However, with the image processing learning program of Non Patent Literature 1 described above, the data set is clustered beforehand. Therefore, although efficiency of learning is improved, since the clustering is sometimes performed based on feature values such as a color, light and shade, and the like of an image, there is a problem in that the clustering does not always link to improvement of accuracy of super resolution.

Therefore, an object of one of embodiments is to provide an image processing training program for clustering, without requiring labeling in advance, a data set used for training of image processing and performing the training of the image processing models such that accuracy of the image processing for classification domains is improved, a trained image processing program, and an information processing apparatus and an image processing system.

### SUMMARY OF INVENTION

An aspect of embodiments provide, in order to achieve the object, an image processing learning program, an image processing program, an information processing apparatus, and an image processing system explained below.

An aspect of embodiments is a non-transitory computer-readable medium having stored thereon instructions, that when executed by a processor, causes the processor to process the following steps (S-1)-(S-8). The step (S-1) includes preparing a plurality of target images. The step (S-2) includes preparing a plurality of training images, where each of the plurality of training images is prepared by lowering a resolution of a corresponding target image of the plurality of target images. The step (S-3) includes, for each of the plurality of training images, training and updating a first super-resolution model by executing the following substeps a) to d): a) inputting a training image of the plurality of training images into the first super-resolution model and generating a higher-resolution training image, b) comparing the higher-resolution training image with a corresponding target image of the plurality of target images, c) calculating a difference between the higher-resolution training image and the corresponding target image, and d) updating the first super-resolution model through a feedback of the calculated difference. The step (S-4) includes, for each of the plurality of training images, training a second super-resolution model in a same manner as training the first super-resolution model by executing the substeps a) to d) in the step (S-3), and updating the second super-resolution model. The step (S-5) includes labeling each of the plurality of training images based on the differences obtained from the updated first super-resolution model and the updated second super-resolution model through the substep d) in the step (S-3), and classifying each of the plurality of training images according to each label representing a preference of either the updated first super-resolution model or the updated second super-resolution model. The step (S-6) includes, using each of the plurality of training images that are clustered in a largest cluster, based on the classification of the plurality of training images, that includes a greatest number of the plurality of training images having a commonly preferred updated super-resolution model, training a super-resolution model-K in a same manner as training the first super-resolution model by executing the substeps a) to d) in the step (S-3), and thereby updating the super-resolution model-K, wherein K is an arbitrary number in a sequence. The step (S-7) includes updating the label of each of the training images of the plurality of training images in the largest cluster based on differences obtained from the updated super-resolution model-K and the commonly preferred updated super-resolution model, and re-classifying the training images of the plurality of training images in the largest cluster into sub-clusters according to each of the updated label representing a preference of either the updated super-resolution model-K or the commonly preferred updated super-resolution model. The step (S-8) includes repeating the steps (S-6)-(S-7) to generate sub-clusters until a predetermined condition is satisfied.

Another aspect of embodiments is a non-transitory computer-readable medium having stored thereon instructions, that when executed by a processor, causes the processor to process the following steps (S-1)-(S-8). The step (S-1) includes preparing a plurality of target images. The step (S-2) includes preparing a plurality of training images, wherein each of the plurality of training images is prepared by lowering a resolution of a corresponding target image of the plurality of target images. The step (S-3) includes, for each of the plurality of training images, training and updating a first super-resolution model by executing the following substeps a) to d): a) inputting the training image in the first super-resolution model and generate a higher-resolution training image, b) comparing the higher-resolution training image with the corresponding target image of the plurality of target images, c) calculating a difference between the higher-resolution training image and the corresponding target image, and d) updating the first super-resolution model through a feedback of the calculated difference, wherein the calculated difference is recorded as resolution accuracy of the first-resolution model to the corresponding training image. The step (S-4) includes, for each of the plurality of training images, training a second super-resolution model in a same manner as training the first super-resolution model by executing the substeps a) to d) in the step (S-3), and updating the second super-resolution model. The step (S-5) includes determining which one of updated super-resolution models preferably resolved a greatest number of the plurality of training images. The step (S-6) includes, using each of the plurality of training images of the greatest number of the plurality of training images resolved by the preferred updated super-resolution model, train a super-resolution model-K in a same manner as training the first super-resolution model by executing the substeps a) to d) in the step (S-3), and updating the super-resolution model-K, wherein K is an arbitrary number in a sequence. The step (S-7) includes, using each of all the plurality of training images, training all of the updated super-resolution models including the updated super-resolution model-K, in a same manner as training the first super-resolution model by executing the substeps a) to d) in (S-3). The step (S-8) includes repeating the steps (S-6)-(S-7) to update the resolution accuracy of each of the updated super-resolution models corresponding to each of the plurality of training images, until a predetermined condition is satisfied.

Yet another aspect of embodiments is a method for processing images that includes the following steps (S-1)-(S-8), by one or more computing devices. The step (S-1) includes preparing a plurality of target images. The step (S-2) includes preparing a plurality of training images, wherein each of the plurality of training images is prepared by lowering a resolution of a corresponding target image of the plurality of target images. The step (S-3) includes, for each of the training images, training and updating a first super-resolution model by executing the following substeps a) to d): a) inputting the training image in the first super-resolution model and generate a higher-resolution training image, b) comparing the higher-resolution training image with a corresponding target image of the plurality of target images, c) calculating a difference between the higher-resolution training image and the corresponding target image, and d) updating the first super-resolution model through a feedback of the calculated difference. The step (S-4) includes, for each of the plurality of training images, training a second super-resolution model in a same manner as training the first super-resolution model by executing the substeps a) to d) in the step (S-3), and updating the second super-resolution model. The step (S-5) includes labeling each of the plurality of training images based on the differences obtained from the updated first super-resolution model and the updated second super-resolution model through the substep d) in the step (S-3), and classifying each of the plurality of training images according to each label representing a preference of either the updated first super-resolution model or the updated second super-resolution model. The step (S-6) includes, using each of the plurality of training images that are clustered in a largest cluster, based on the classification of the plurality of training images, that includes a greatest number of the plurality of training images having a commonly preferred updated super-resolution model, training a super-resolution model-K in a same manner as training the first super-resolution model by executing the substeps a) to d) in the step (S-3), and updating the super-resolution model-K, wherein K is an arbitrary number in a sequence. The step (S-7) includes updating the label of each of the training images of the plurality of training images in the largest cluster based on differences obtained from the updated super-resolution model-K and the commonly preferred updated super-resolution model, and re-classifying the training images of the plurality of training images in the largest cluster into sub-clusters according to each of the updated label representing a preference of either the updated super-resolution model-K or the commonly preferred updated super-resolution model. The step (S-8) includes repeating the steps (S-6)-(S-7) to generate sub-clusters.

### BRIEF DESCRIPTION OF DRAWINGS

FIG. 1 is a schematic diagram illustrating an example of the configuration of an image processing system according to a first embodiment.

FIG. 2 is a block diagram illustrating a configuration example of a terminal according to the first embodiment.

FIG. 3 is a schematic diagram for explaining a super-resolution operation of the terminal.

FIG. 4 is a flowchart illustrating an example of the super-resolution operation of the terminal in the first embodiment.

FIG. 5A is a schematic diagram for explaining a training operation of the terminal in the first embodiment.

FIG. 5B is a schematic diagram for explaining the training operation of the terminal in the first embodiment.

FIG. 5C is a schematic diagram for explaining the training operation of the terminal in the first embodiment.

FIG. 5D is a schematic diagram for explaining the training operation of the terminal in the first embodiment.

FIG. 5E is a schematic diagram for explaining the training operation of the terminal in the first embodiment.

FIG. 5F is a schematic diagram for explaining the training operation of the terminal in the first embodiment.

FIG. 5G is a schematic diagram for explaining the training operation of the terminal in the first embodiment.

FIG. 6 is a flowchart illustrating an example of the training operation of the terminal in the first embodiment.

FIG. 7A is a schematic diagram for explaining a training operation of a terminal in a second embodiment.

FIG. 7B is a schematic diagram for explaining the training operation of the terminal in the second embodiment.

FIG. 7C is a schematic diagram for explaining the training operation of the terminal in the second embodiment.

FIG. 8 is a flowchart illustrating an example of the training operation of the terminal in the second embodiment.

### DESCRIPTION OF EMBODIMENTS

Various embodiments of the present invention may be described with reference to flowcharts and block diagrams whose elements may represent (1) steps of processes in which operations are performed or (2) sections of apparatuses responsible for performing operations. Certain steps and sections may be implemented by dedicated circuitry, programmable circuitry, and/or processors supplied with computer-readable instructions stores on computer-readable media.

### First Embodiment

### (Configuration of an Image Processing System)

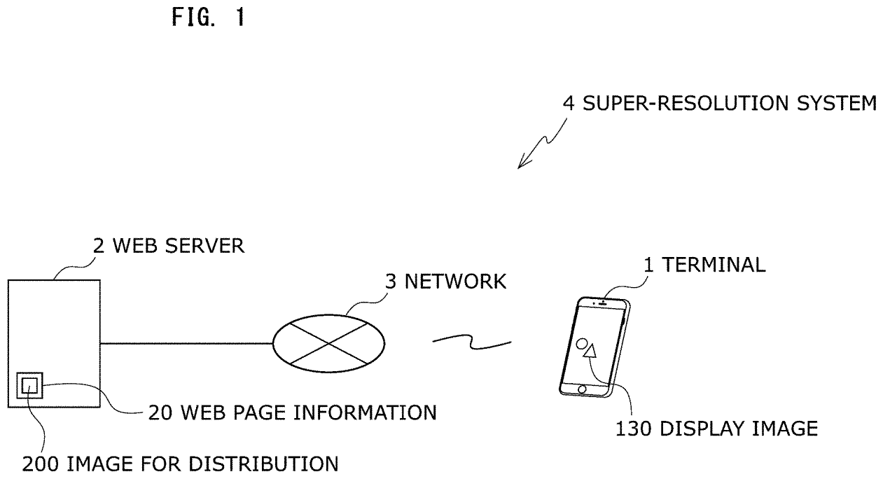

FIG. 1 is a schematic diagram illustrating an example of the configuration of an image processing system according to a first embodiment.

A super-resolution system 5 as an example of this image processing system is configured by communicably connecting a terminal 1 functioning as an information processing apparatus and a Web server 2 to each other by a network 3.

The terminal 1 is an information processing apparatus of a portable type such as a notebook personal computer (PC), a smartphone, or a tablet terminal and includes, in a main body, electronic components such as a central processing unit (CPU) having a function of processing information, a graphics processing unit (GPU), and a flash memory. Note that the terminal 1 is not limited to the information processing apparatus of the portable type and may be a PC of a stationary type.

The Web server 2 is a server-type information processing apparatus and operates according to a request of the terminal 1. The Web server 2 includes, in a main body, electronic components such as a CPU having a function of processing information and a flash memory.

The network 3 is a communication network capable of performing high-speed communication and is, for example, a wired or wireless communication network such as the Internet or a local area network (LAN).

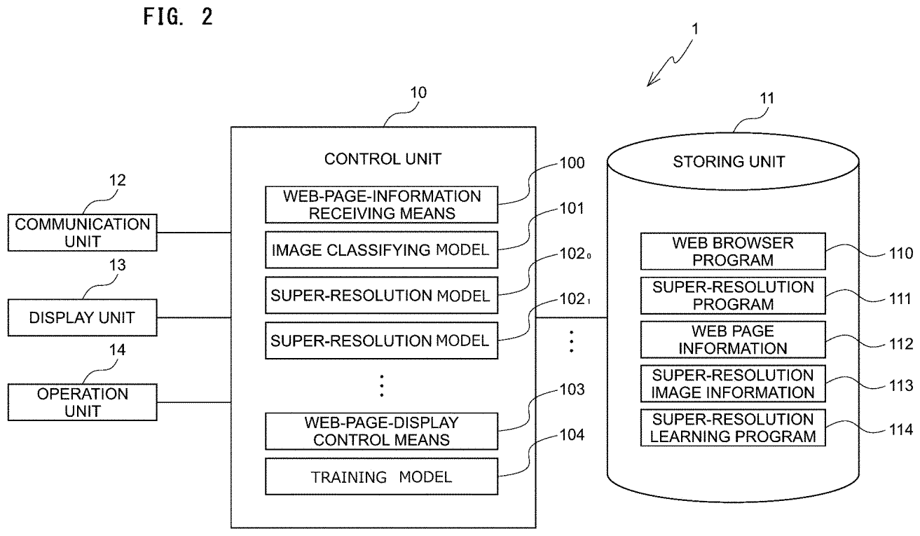

As an example, the terminal 1 transmits a request to the Web server 2 for browsing a Web page. In response to the request, the Web server 2 transmits, to the terminal 1, Web page information 20 forming a Web page including an image for distribution 200 to be displayed on the Web page. The terminal receives the Web page information 20 and the image for distribution 200 and classifies the image for distribution 200, which is an input image, into a category. As an example of image processing, the terminal 1 converts the image for distribution 200 into a high-resolution (super-resolution) image using a super-resolution model suitable for the category and displays a display image 130 on a display unit (13, see FIG. 2) based on the Web page information 20. Note that the super-resolution means single image super-resolution for restoring a single high-resolution image from a single low-resolution image (the same applies below). The terminal 1 includes a plurality of super-resolution models that are respectively suitable for a plurality of categories and selectively employs one of the plurality of super-resolution models that is best suited for super-resolving the input image of the category. By selectively using a super-resolution model out of the plurality of super-resolution models, the accuracy of super resolution is improved compared with a processing performed by a single super-resolution model. Note that the image for distribution 200 is image information having lower resolution compared with the display image 130 and is information with a less data amount. The plurality of super-resolution models are trained by methods explained below. Clustering of training images is performed in preparation for a training of a classification model during a training stage of the plurality of super-resolution models.

### (Configuration of the Information Processing Apparatus)

FIG. 2 is a block diagram illustrating a configuration example of the terminal 1 according to the first embodiment.

The terminal 1 is configured from a CPU, a GPU, or the like and includes a control unit 10 that controls units and executes various programs, a storing unit 11 that is configured from a storage medium such as a flash memory and stores information, a communication unit 12 that communicates with the outside via the network 3, a display unit 13 that is configured from a liquid crystal display (LCD) or the like and displays characters and images, and an operation unit 14 that is configured from a touch panel, a keyboard, switches, and the like, which can be touched and operated, arranged on the display unit 13 and receives operation by a user.

The control unit 10 executes a Web browser program 110 explained below to function as Web-page-information receiving means 100, Web-page-display control means 103, and the like. The control unit 10 executes a super-resolution program 111 functioning as an image processing program explained below to function as an image classifying model 101, a plurality of super-resolution models 102₀, 102₁, . . . , and the like. The control unit 10 executes a super-resolution learning program 114 functioning as an image processing training program explained below to function as training means 104 for training the image classifying model 101, the plurality of super-resolution models 102₀, 102₁, . . . , and the like.

The Web-page-information receiving means 100 receives the Web page information 20 including the image for distribution 200 from the Web server 2 via the communication unit 12 and stores the Web page information 20 in the storing unit 11 as Web page information 112. Note that the storage of the Web page information 112 may be temporary.

The trained image classifying model 101 classifies the image for distribution 200 received by the Web-page-information receiving means 100 into a category and selects super-resolution models suitable for the category of the image for distribution 200 among the plurality of trained super-resolution models 102₀, 102₁, . . . . Note that the image classifying model 101 is trained, for example, by using a CNN (Convolutional Neural Network) but may be trained with logistic regression, a support vector machine, a decision tree, a random forest, Stochastic Gradient Descent (SGD), Kernel density estimation, a k-nearest neighbors algorithm, perceptron, or the like.

The plurality of trained super-resolution models 102₀, 102₁, . . . functioning as image processing models are super-resolution models specialized for super resolution of images in respective different categories. The plurality of trained super-resolution models 102₀, 102₁, . . . super-resolve the image for distribution 200 serving as an input image classified by the trained image classifying model 101, generate high-resolution super-resolution image information 113 serving as an output image, and store the super-resolution image information 113 in the storing unit 11. Note that the super-resolution models 102₀, 102₁, . . . are trained, for example, by using the CNN but may be trained with an equivalent algorithm.

The Web-page-display control means 103 displays, based on the Web page information 112, the display image 130 of the Web page on the display unit 13 instead of the image for distribution 200 using the super-resolution image information 113.

The training model 104 causes the untrained image classifying model 101 and the plurality of untrained super-resolution models 102₀, 102₁, . . . to learn. Details of training methods for learning are explained below. Note that the training model 104 and the super-resolution learning program 114 are not essential components for the terminal 1 and are generally executed and stored by different apparatuses and are included in the configuration for convenience of explanation. That is, the training model 104 and the super-resolution learning program 114 only have to be executed by the different apparatuses. The trained image classifying model 101, the plurality of trained super-resolution models 102₀, 102₁, . . . , and the super-resolution program 111 as a result of training in the different apparatuses only have to be included in the terminal 1.

The storing unit 11 stores the Web browser program 110 for causing the control unit 10 to operate as the means 100 and 103 explained above, the super-resolution program 111 for causing the control unit 10 to operate as the models 101, 102₀, 102₁, . . . explained above, the Web page information 112, the super-resolution image information 113, the super-resolution learning program 114 for causing the control unit 10 to operate as the training model 104 explained above, and the like.

### (Operation of the Super-Resolution System)

Next, actions of this embodiment are divided into (1) a super-resolution operation and (2) a training operation, and are explained respectively. In the “(1) super-resolution operation”, the operation of executing the super-resolution program 111 trained by the “(2) training operation” and super-resolving of the image for distribution 200 is explained. In the “(2) learning operation”, the operation for executing the super-resolution learning program 114 to cause the image classifying model 101 and the plurality of super-resolution models 102₀, 102₁, . . . to learn is explained.

### (1) Super-Resolution Operation

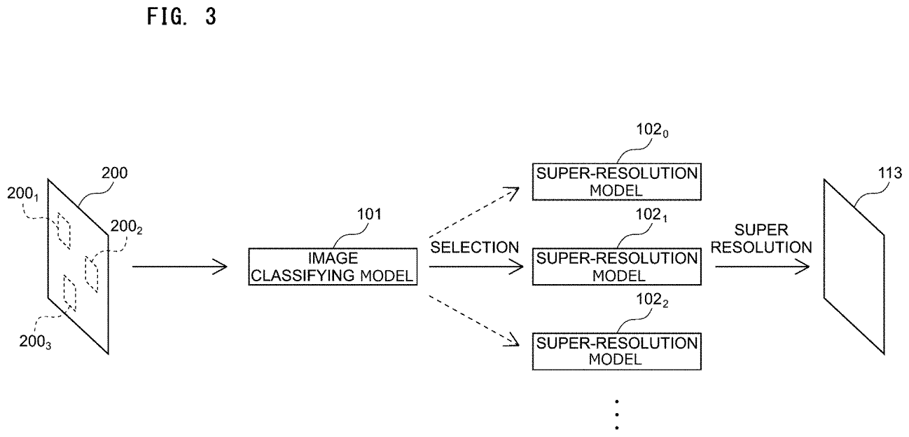

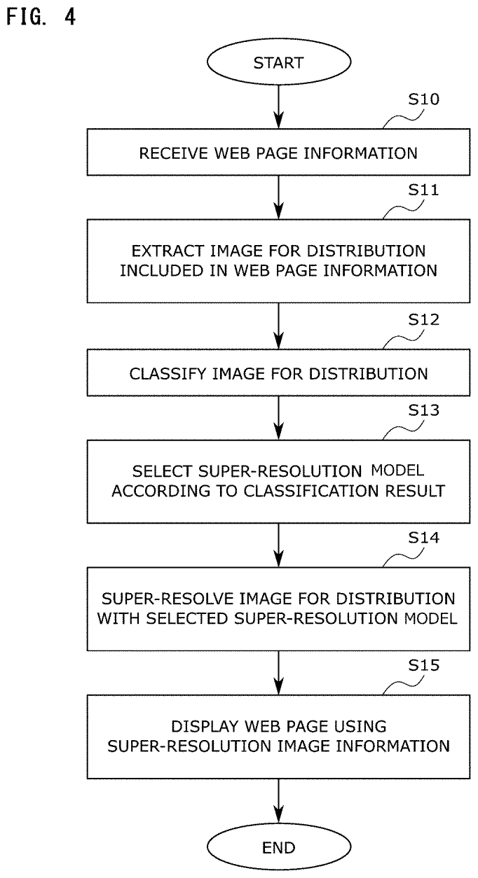

FIG. 3 is a schematic diagram for explaining the super-resolution operation of the terminal 1. FIG. 4 is a flowchart illustrating an example of the super-resolution operation of the terminal 1.

First, the Web-page-information receiving means 100 of the terminal 1 receives the Web page information 20 including the image for distribution 200 from the Web server 2 via the communication unit 12 and stores the Web page information 20 in the storing unit 11 as the Web page information 112 (S10).

Subsequently, the trained image classifying model 101 of the terminal 1 extracts the image for distribution 200 from the Web page information 20 received by the Web-page-information receiving means 100 (S11).

Subsequently, the trained image classifying model 101 extracts, from the extracted image for distribution 200, a plurality of patches 200₁, 200₂, 200₃, . . . as partial regions. The trained image classifying model 101 performs patch processing of the plurality of patches 200₁, 200₂, 200₃, . . . and obtains outputs for the plurality of patches 200₁, 200₂, 200₃, . . . . The trained image classifying model 101 operates based on the super-resolution program 111 serving as a training result, classifies the image for distribution 200 into a category from a value obtained by averaging the outputs for the plurality of patches 200₁, 200₂, 200₃, . . . (S12) and selects, among the plurality of trained super-resolution models 102₀, 102₁, . . . , for instance, the trained super-resolution model 102₁ corresponding to a category of a classification result and most suitable for super resolution of the image for distribution 200 (S13).

Subsequently, the trained super-resolution model 102₁ selected by the trained image classifying model 101 super-resolves the image for distribution 200 (S14), generates high-resolution super-resolution image information 113, and stores the high-resolution super-resolution image information 113 in the storing unit 11.

Subsequently, the Web-page-display control means 103 of the terminal 1 displays, based on the Web page information 112, the display image 130 of the Web page on the display unit 13 using the super-resolution image information 113 instead of the image for distribution 200 (S15).

### (2) Learning Operation

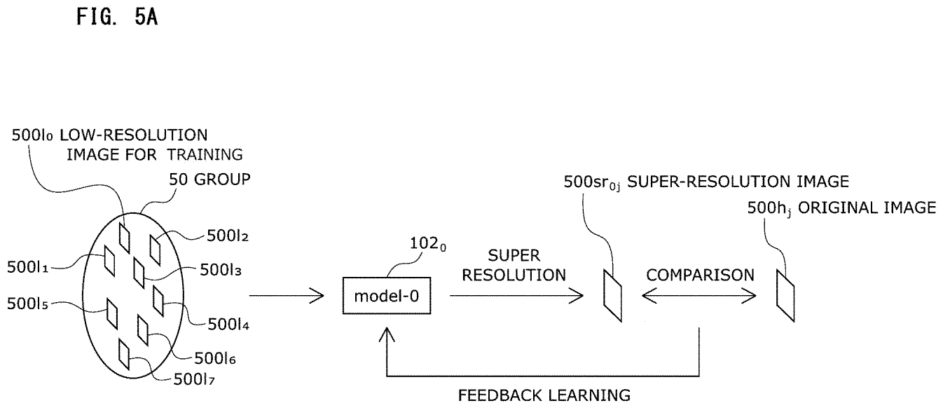

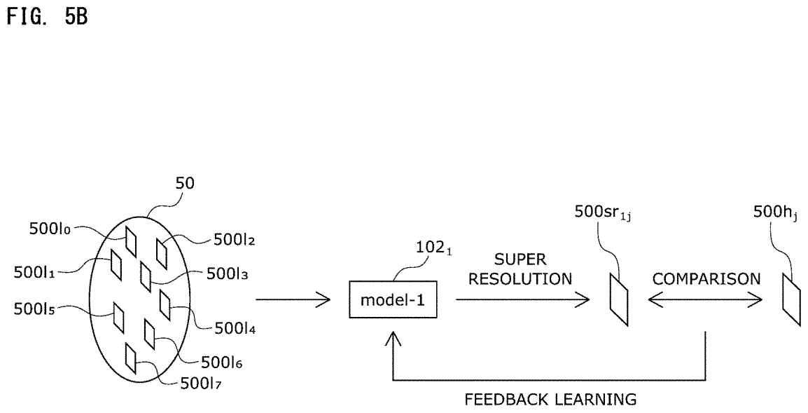

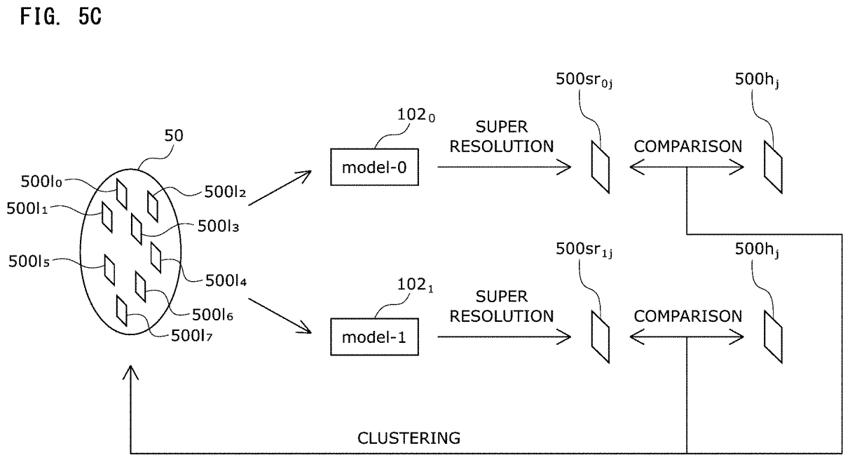

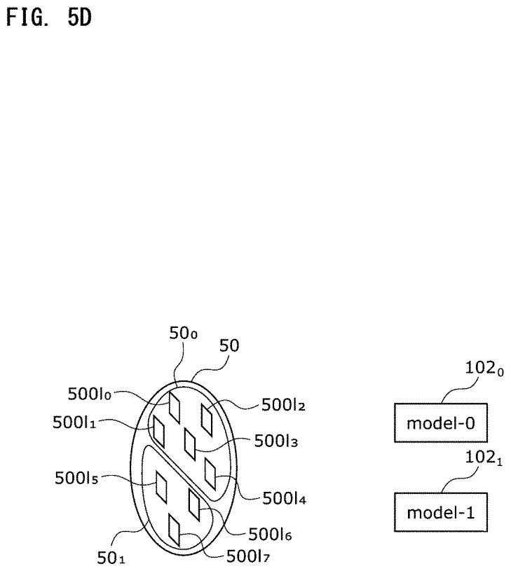

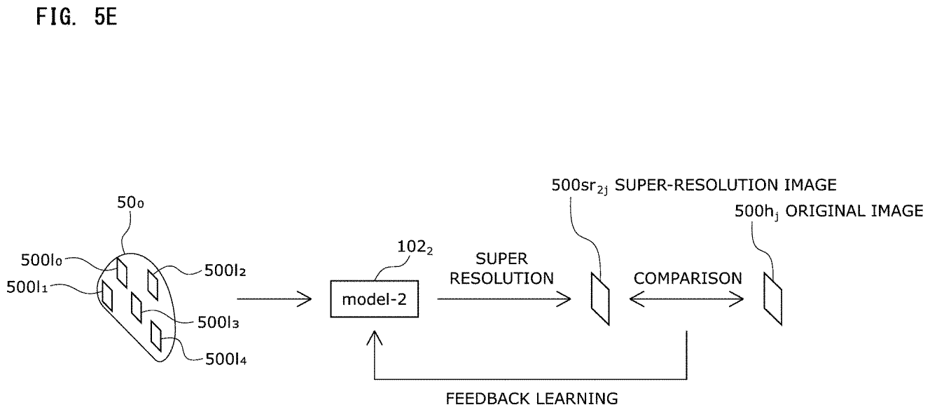

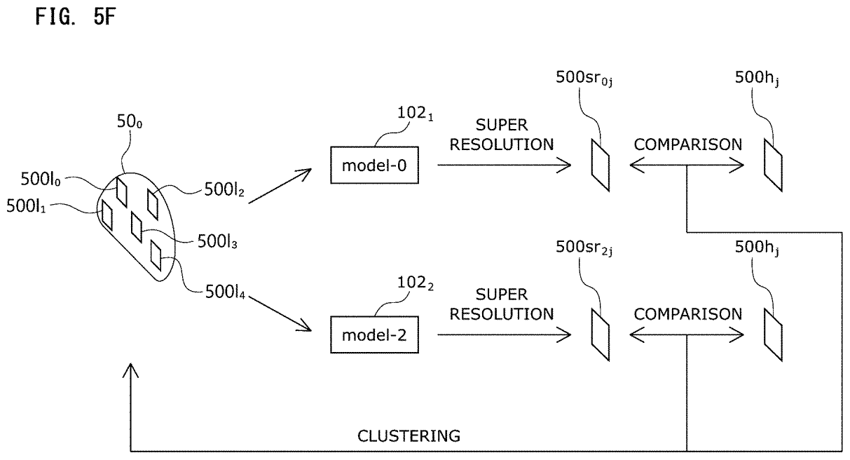

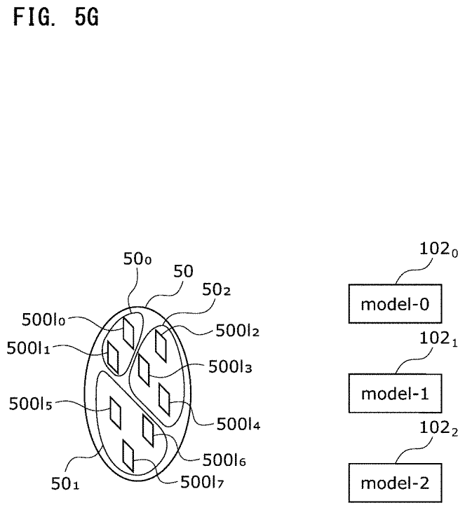

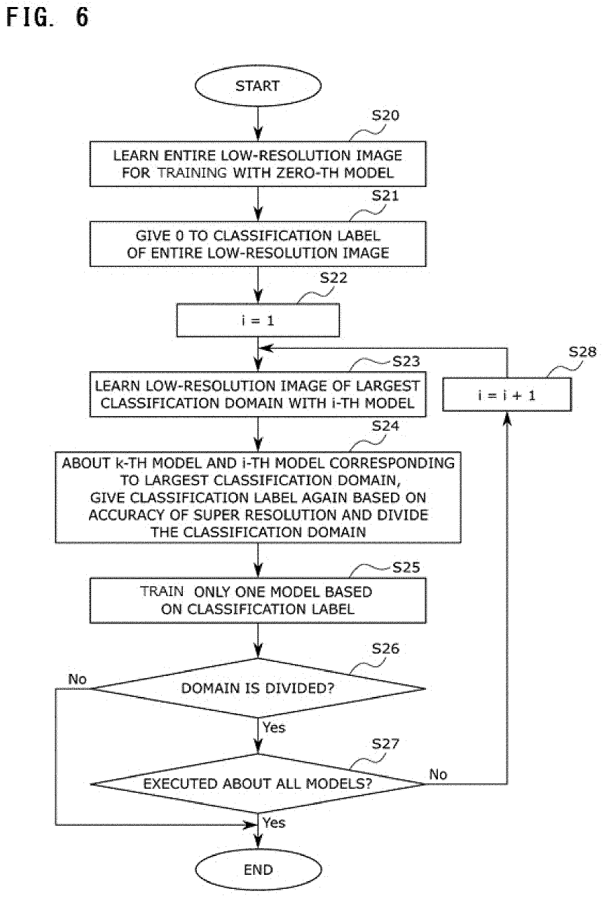

FIG. 5A to FIG. 5G are schematic diagrams for explaining the learning operation of the terminal 1 in the first embodiment. FIG. 6 is a flowchart illustrating an example of the learning operation of the terminal 1 in the first embodiment.

First, as illustrated in FIG. 5A, the training model 104 of the terminal 1 trains the super-resolution model 102₀, which is untrained zero-th super-resolution model, with entire low-resolution images for learning 500l₀ to 500l₇ included in an entire group 50, which is a learning target (S20). A training method is explained below.

The super-resolution model 102₀ super-resolves a j-th low-resolution image for learning 500lⱼ of the low-resolution images for learning 500l₀ to 500l₇ and obtains a super-resolution image 500sr0ⱼ. Subsequently, the training model 104 compares the super-resolution image 500sr0ⱼ with a j-th original image 500hⱼ of original images 500h₀ to 500h₇ serving as target images having higher resolution than the low-resolution images for learning 500l₀ to 500l₇ prepared in advance and calculates differences. As the difference, for example, a mean squared error (MSE) or a mean absolute error (MAE) is used. The differences may be calculated by using a CNN that has been trained to calculate difference. The training model 104 feeds back the differences and train the super-resolution model 102₀ about the entire low-resolution images for learning 500l₀ to 500l₇ such that the differences decrease. In the following explanation, the difference being small is referred to as “accuracy of super resolution is high”.

Subsequently, as illustrated in FIG. 5B, the training model 104 of the terminal 1 trains the super-resolution model 102₁, which is an untrained first super-resolution model (S22), with a largest classification domain among classification domains included in the entire group 50, that is, since classification is not performed yet in the case of FIG. 5B, the entire low-resolution images for learning 500l₀ to 500l₇ (S23). A training method is the same as the training of the zero-th super-resolution model as explained below.

The super-resolution model 102₁ super-resolves the j-th low-resolution image for learning 500lⱼ of the low-resolution images for learning 500l₀ to 500l₇ and obtains a super-resolution image 500sr1ⱼ. Subsequently, the training model 104 compares the super-resolution image 500sr1ⱼ with the j-th original image 500hⱼ of the high-resolution original images 500h₀ to 500h₇ of the low-resolution images for learning 500l₀ to 500l₇ prepared in advance and calculates differences. The training model 104 feeds back the differences and trains the super-resolution model 102₁ with the entire low-resolution images for learning 500l₀ to 500l₇ such that the differences decrease.

Note that the training model 104 may copy the trained super-resolution model 102₀ as the super-resolution model 102₁ and reduce a time required for training and cost of processing.

Subsequently, as illustrated in FIG. 5C, the training model 104 of the terminal 1 performs super resolution with the super-resolution model 102₀, which is k-th super-resolution model corresponding to the largest classification domain, that is, in the case of FIG. 5C, k=0-th super-resolution model, and the super-resolution model 102₁, which is i=1-st super-resolution model, gives, again, based on accuracy of the super resolution, classification labels of the low-resolution images for learning 500l₀ to 500l₇ included in the entire group 50, which is the largest classification domain, and divides a classification domain (S24), and causes, based on the classification label, one super-resolution model 102₀ or super-resolution model 102₁ having high accuracy to learn (S25). Details of a dividing method and a learning method are explained below.

The super-resolution model 102₀ and the super-resolution model 102₁ super-resolve the j-th low-resolution image for learning 500lⱼ of the low-resolution images for learning 500l₀ to 500l₇ and obtain the super-resolution image 500sr0ⱼ and the super-resolution image 500sr1ⱼ. Subsequently, the training model 104 compares the super-resolution image 500sr0ⱼ and the super-resolution image 500sr1ⱼ with the high-resolution original image 500hⱼ and calculates differences. The training model 104 gives, to the low-resolution image for learning 500lⱼ, a classification label (0 or 1) of the super-resolution model 102₀ or the super-resolution model 102₁ that outputs the super-resolution image 500sr0ⱼ or the super-resolution image 500sr1ⱼ having the smaller difference and clusters the group 50 and feeds back the j-th low-resolution image for learning 500lⱼ to the super-resolution model 102₀ or the super-resolution model 102₁ having the smaller difference and cause the super-resolution model 102₀ or the super-resolution model 102₁ to learn the j-th low-resolution image for learning 500lⱼ. Note that, when the differences coincide about the super-resolution model 102₀ and the super-resolution model 102₁, the training model 104 selects one of the super-resolution model 102₀ and the super-resolution model 102₁, gives the classification label (0 or 1) to the low-resolution image for learning 500lⱼ, and clusters the group 50 and feeds back the j-th low-resolution image for learning 500lⱼ to the selected super-resolution model 102₀ or super-resolution model 102₁ and causes the super-resolution model 102₀ or the super-resolution model 102₁ to learn the j-th low-resolution image for learning 500lⱼ. The super-resolution model to which the low-resolution image for learning 500lⱼ is fed back to cause the super-resolution model to learn the low-resolution image for learning 500lⱼ does not always need to be one of the super-resolution model 102₀ and the super-resolution model 102₁. The super-resolution model 102₀ and the super-resolution model 102₁ may be weighted based on accuracies thereof and caused to learn. That is, weight for the feedback and the learning may be set large for either of the super-resolution model 102₀ or the super-resolution model 102₁ whichever having the smaller difference, and the weight for the feedback and the learning may be set small for either of the super-resolution model 102₀ or the super-resolution model 102₁ whichever having the larger difference.

As a result of the clustering, as illustrated in FIG. 5D, the group 50 is divided into a group 500 to which the label 0 of the super-resolution model 102₀ is given and a group 501 to which the label 1 of the super-resolution model 102₁ is given. As a result of the training, the super-resolution model 102₀ and the super-resolution model 102₁ are respectively trained with higher accuracy, that is, accuracies of super resolution are respectively optimized about the group 50₀ and the group 50₁ compared with when the group 50₀ and the group 50₁ are super-resolved by the other super-resolution model 102₀ and super-resolution model 102₁.

If the domain is divided (S26; Yes), the training model 104 of the terminal 1 executes steps S23 to S25 about the next untrained super-resolution model (S27; No, S28).

Subsequently, as illustrated in FIG. 5E, the training model 104 of the terminal 1 trains the super-resolution model 102₂, which is an untrained second super-resolution model (S22), with the largest classification domain among the classification domains included in the entire group 50, that is, in the case of FIG. 5E, the entire low-resolution images for learning 500l₀ to 500l₄ included in the group 502 (S23). Note that the training model 104 may copy the trained super-resolution model 102₀ as the super-resolution model 102₂ and reduce a time required for training and cost of processing.

Subsequently, as illustrated in FIG. 5F, the training model 104 of the terminal 1 performs super resolution with the super-resolution model 102₀, which is k-th super-resolution model corresponding to the largest classification domain, that is, in the case of FIG. 5F, k=0-th super-resolution model, and the super-resolution model 102₂, which is i=2-nd super-resolution model, and gives, again, based on accuracy of super resolution, classification labels of the low-resolution images for learning 500l₀ to 500l₄ included in the entire group 50₀, which is the largest classification domain, and divides the classification domain (S24), and causes one super-resolution model 102₀ or super-resolution model 102₂ to learn based on the classification labels (S25).

The super-resolution model 102₀ and the super-resolution model 102₂ super-resolve the j-th low-resolution image for learning 500lⱼ of the low-resolution images for learning 500l₀ to 500l₄, respectively, and obtain the super-resolution image 500sr₀ⱼ and a super-resolution image 500sr₂ⱼ. Subsequently, the training model 104 compares the super-resolution image 500sr₀ⱼ and the super-resolution image 500sr₁ⱼ with the high-resolution original image 500hⱼ, respectively, and calculates differences. The training model 104 gives a classification label (0 or 2) of the super-resolution model 102₀ or the super-resolution model 102₂ having the smaller difference to the low-resolution image for learning 500lⱼ and clusters the group 50₀ and feeds back the j-th low-resolution image for learning 500lⱼ to the super-resolution model 102₀ or the super-resolution model 102₂ having the smaller difference and causes the super-resolution model 102₀ or the super-resolution model 102₂ to learn the j-th low-resolution image for learning 500lⱼ. The super-resolution model to which the low-resolution image for learning 500lⱼ is fed back to cause the super-resolution model to learn the low-resolution image for learning 500lⱼ does not always need to be one of the super-resolution model 102₀ and the super-resolution model 102₂. The super-resolution model 102₀ and the super-resolution model 1022 may be weighted based on accuracies thereof and caused to learn.

As explained above, the super resolution is performed by the k-th super-resolution model corresponding to the largest classification domain and the single i-th super-resolution model. The largest classification domain is divided based on the accuracy of the super resolution and the training of the super-resolution model is performed based on the accuracy of the super resolution. However, the super resolution may be performed by the k-th super-resolution model corresponding to the largest classification domain and a plurality of i-th, i+1-th, i+2-th, . . . super-resolution models, where the largest classification domain may be divided based on the accuracy of the super resolution, and the training of the super-resolution models may be performed based on the accuracy of the super resolution.

As a result of the clustering, as illustrated in FIG. 5G, the group 50₀ is divided into the group 50₀ to which the label 0 of the super-resolution model 102₀ is given and a group 50₂ to which the label 2 of the super-resolution model 102₂ is given. As a result of the training, the accuracies of the super resolution of the super-resolution model 102₀, the super-resolution model 102₁, and the super-resolution model 102₂ are respectively optimized about the group 50₀, the group 50₁, and the group 50₂.

When finishing executing steps S23 to S25 about all the prepared super-resolution models (S27; Yes), the training model 104 of the terminal 1 ends the operation. Even when the operation is not executed about all the prepared super-resolution models, if the domain is not divided any more (S26; No), the training model 104 of the terminal 1 ends the operation and stops using the super-resolution model.

When all the steps end, the learning of all the super-resolution models 102₀, 102₁, . . . is completed, and the classification domain of the group 50 is divided, the training model 104 learns the image classifying model 101 about the low-resolution image for learning 500lⱼ to which the classification label of the group 50 is given. Note that, as in the case illustrated in FIG. 3, the image classifying model 101 may be trained by extracting a plurality of patches from the low-resolution image for learning 500lⱼ and performing patch processing or may be directly processed and trained using the low-resolution image for learning 500lⱼ as one patch.

### Effects of the First Embodiment

According to the first embodiment explained above, for super-resolving a single image, when the plurality of super-resolution models 102₀, 102₁, . . . 102ₖ, . . . 102ᵢ are trained, super-resolution model 102k corresponding to a classification domain 50ₖ having the largest amount of data in the data set (the group 50) and super-resolution model 102ᵢ that is to be trained anew using the data in the classification domain 50ₖ are caused to compete and train. A label of the super-resolution model 102ₖ or 102ᵢ having high accuracy of super resolution of an image included in the classification domain 50ₖ is given to the data set (the group 50) and the data set (the group 50) is clustered. The super-resolution model 102ₖ or 102ᵢ having a result with high accuracy is caused to learn with the image and set as the super-resolution model 102ₖ or 102ᵢ optimized for a divided classification domain 50ₖ and 50ᵢ. Therefore, it is possible to cluster the data set (the group 50) used for the training of the super resolution without necessity of labeling the data set (the group 50) in advance. It is possible to efficiently perform the optimization of the classification domains 50ₖ and 50ᵢ and the super-resolution model 102ₖ and 102ᵢ. Since the data set can be spontaneously clustered by the training of the super-resolution model, it is possible to prepare a data set for training of the image classifying model 101 without requiring labeling in advance. It is possible to efficiently train the image classifying model 101.

By preparing the plurality of super-resolution models 102₀, 102₁, . . . and specialized according to a category of an image, it is possible to improve accuracy as a whole and the respective super-resolution models 102₀, 102₁, . . . can be formed as light-weight models. By causing the trained plurality of super-resolution models 102₀, 102₁, . . . and image classifying model 101 to function in the terminal 1, it is possible to reduce the data volume of the image for distribution 200 and reduce a communication volume of the network 3.

### Second Embodiment

A second embodiment is different from the first embodiment in that a classification label is not given in clustering in a training operation. Note that, since a configuration and a super-resolution operation are the same as those in the first embodiment, explanation about the configuration and the super-resolution operation is omitted.

### (3) Training Operation

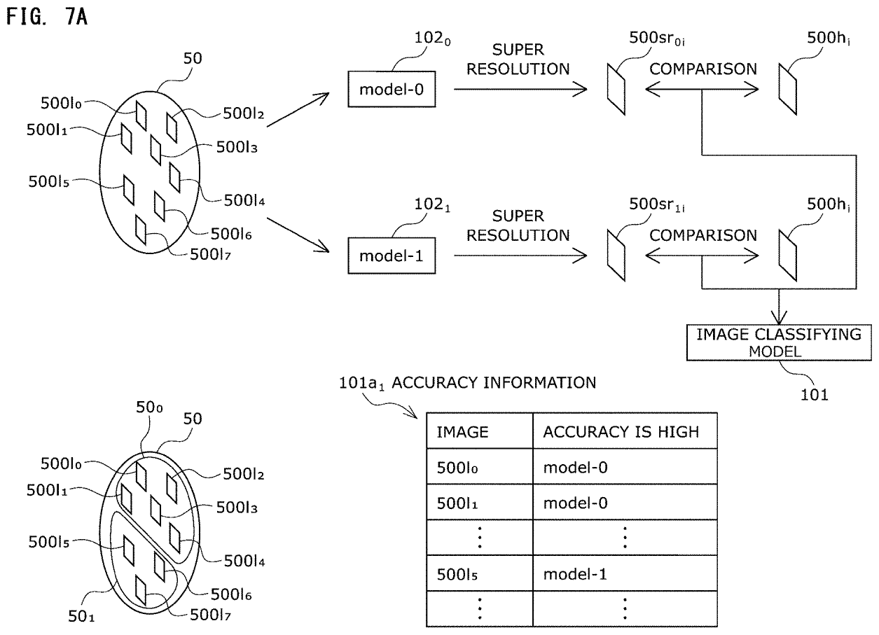

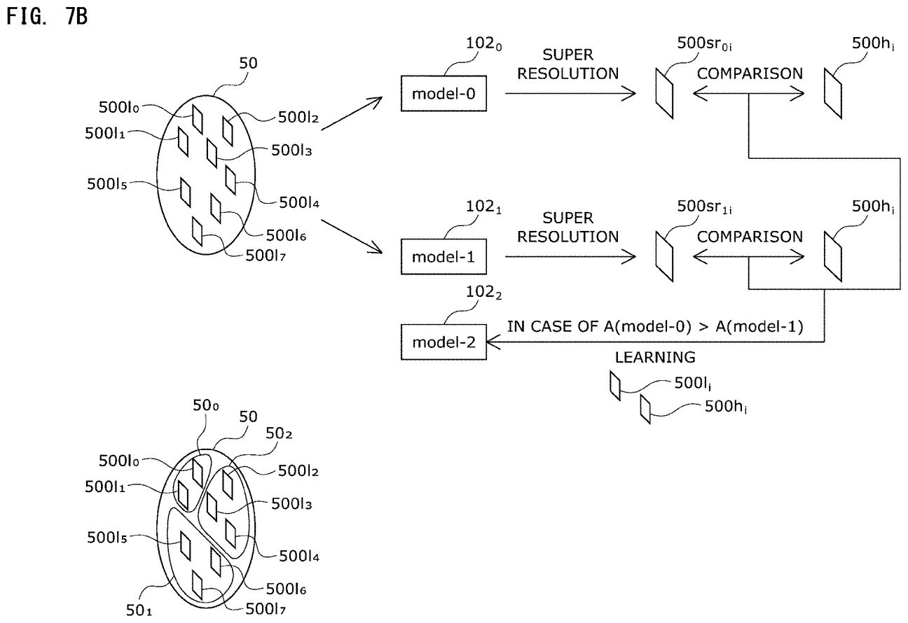

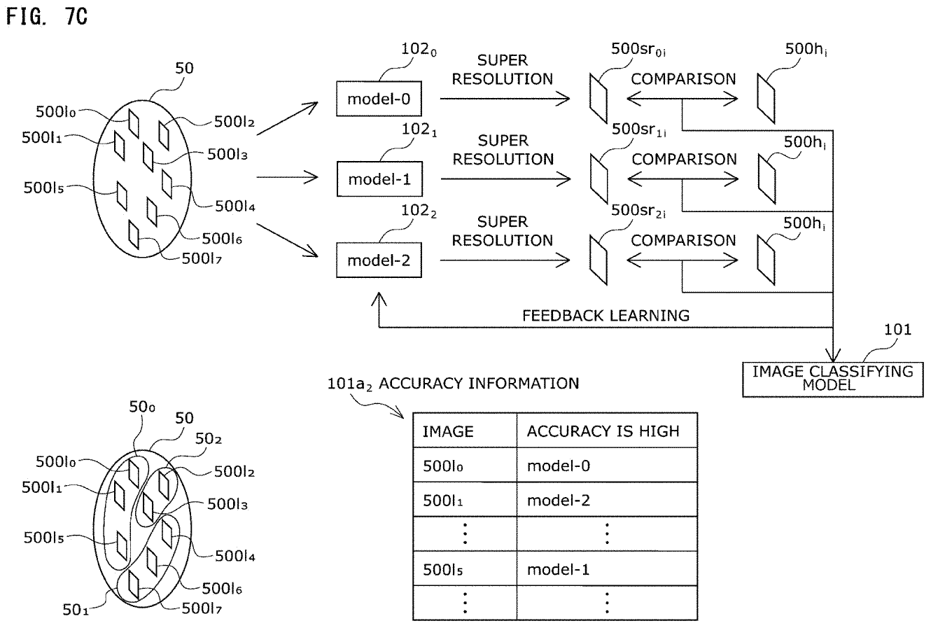

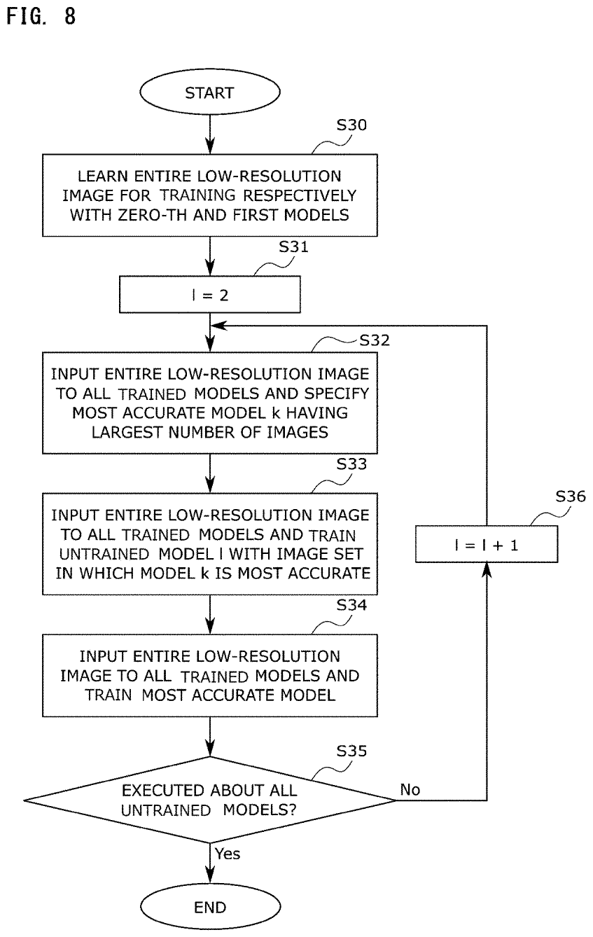

FIG. 7A to FIG. 7C are schematic diagrams for explaining a training operation of the terminal 1 in the second embodiment. FIG. 8 is a flowchart illustrating an example of the training operation of the terminal 1 in the second embodiment.

First, the training model 104 of the terminal 1 trains, with the super-resolution model 102₀ and the super-resolution model 102₁, which are untrained zero-th and first super-resolution model, the entire low-resolution images for learning 500l₀ to 500l₇ included in the entire group 50, which is a learning target, (S30). Note that, since a training method is the same as the training method in the first embodiment, explanation about the training method is omitted.

Subsequently, the training model 104 of the terminal 1 sets a variable l=2 (S31) and, as illustrated in an upper part of FIG. 7A, inputs the entire low-resolution images for learning 500l₀ to 500l₇ included in the entire group 50, which is the learning target, to the trained super-resolution model 102₀ and super-resolution model 102₁, super-resolves an i-th low-resolution image for learning 500lᵢ, and obtains super-resolution images 500sr₀ᵢ and 500sr₁ᵢ. Subsequently, the image classifying model 101 compares the super-resolution images 500sr₀ᵢ and 500sr₁ᵢ with an i-th original image 500hᵢ of the high-resolution original images 500h₀ to 500h₇ of the low-resolution images for learning 500l₀ to 500l₇ prepared in advance, records super-resolution model having a small difference, that is, super-resolution model having high accuracy as accuracy information 101a₁ as illustrated in a lower part of FIG. 7A, and specifies a most accurate model k having the largest number of images (S32). In the case of FIG. 7A, k=0. Note that the recording of the accuracy information 101a1 may be temporarily stored. In this state, conceptually, the group 50 is divided into the group 50₀ highly accurately super-resolved by the super-resolution model 102₀ and the group 50₁ highly accurately super-resolved by the super-resolution model 102₁.

Subsequently, as illustrated in an upper part of FIG. 7B, the training model 104 of the terminal 1 inputs the entire low-resolution images for learning 500l₀ to 500l₇ included in the entire group 50, which is the learning target, to the trained super-resolution model 102₀ and super-resolution model 102₁, super-resolves the i-th low-resolution image for learning 500lᵢ, respectively, and obtains the super-resolution images 500sr₀ᵢ and 500sr₁ᵢ. Subsequently, the image classifying model 101 compares the super-resolution images 500sr₀ᵢ and 500sr₁ᵢ with the i-th original image 500hᵢ of the high-resolution original images 500h₀ to 500h₇ of the low-resolution images for learning 500l₀ to 500l₇ prepared in advance and causes a untrained 1-st super-resolution model, that is, super-resolution model 102₁ to learn using a training set of the i-th low-resolution image for learning 500lᵢ having the smallest difference from the super-resolution image 500sr₀ᵢ and the original image 500hᵢ (S33). The training of the super-resolution model 102₁ is performed until accuracy becomes the same degree as the accuracy of the super-resolution model 102₀. In this state, as illustrated in a lower part of FIG. 7B, conceptually, the group 50 is divided into the group 50₀ highly accurately super-resolved by the super-resolution model 102₀, the group 50₁ highly accurately super-resolved by the super-resolution model 102₁, and the group 50₂ highly accurately super-resolved by the super-resolution model 102₂. That is, compared with the state illustrated in the lower part of FIG. 7A, this state is a state in which a group highly accurately super-resolved by the super-resolution model 102₁ is divided into two.

Subsequently, as illustrated in an upper part of FIG. 7C, the training model 104 of the terminal 1 inputs the entire low-resolution images for learning 500l₀ to 500l₇ included in the entire group 50, which is the training target, to the trained super-resolution model 102₀, super-resolution model 102₁, and super-resolution model 102₂, super-resolves the i-th low-resolution image for learning 500lᵢ, and obtains the super-resolution images 500sr₀ᵢ, 500sr₁ᵢ, and 500sr2i, respectively. Subsequently, the image classifying model 101 compares the super-resolution images 500sr₀ᵢ, 500sr₁ᵢ, and 500sr₂ᵢ with the i-th original image 500hᵢ of the high-resolution original images 500h₀ to 500h₇ of the low-resolution images for learning 500l₀ to 500l₇ prepared in advance and trains the super-resolution model having the smallest difference, that is, the super-resolution model having the highest accuracy by feeding back the training set of the i-th low-resolution image for learning 500lᵢ and the original image 500hᵢ (S34).

In this state, as illustrated in a lower part of FIG. 7C, conceptually, the group 50 is divided into the group 50₀ highly accurately super-resolved by the super-resolution model 102₀, the group 50₁ highly accurately super-resolved by the super-resolution model 102₁, and the group 50₂ highly accurately super-resolved by the super-resolution model 102₂. Note that the result of divided groups does not always coincide with the state illustrated in the lower part of FIG. 7B because, as a result of performing the feedback training, changes occur in the super-resolution model 102₀, the super-resolution model 102₁, and the super-resolution model 102₂.

As illustrated in a lower part of FIG. 7C, the image classifying model 101 compares the super-resolution images 500sr₀ᵢ, 500sr₁ᵢ, and 500sr₂ᵢ with the i-th original image 500hᵢ of the high-resolution original images 500h₀ to 500h₇ of the low-resolution images for learning 500l₀ to 500l₇ prepared in advance, records super-resolution model having a small difference, that is, super-resolution model having high accuracy as accuracy information 101a₂ and specifies the most accurate model k having the largest number of images (S32). In the case of FIG. 7C, k=0 or 1.

In this way, steps S32 to S34 are executed about all untrained models (S35, S36).

When all the steps explained above end and the training of all the super-resolution models 102₀, 102₁, . . . is completed, the training model 104 trains the image classifying model 101 about the group 50 using finally obtained accuracy information 101a₁.

### Effects of the Second Embodiment

According to the second embodiment explained above, in super-resolving a single image, when the plurality of super-resolution models 102₀, 102₁, . . . are caused to learn, a super-resolution model having high accuracy is quantified and the super-resolution model 102ₖ corresponding to the classification domain 50ₖ in the data set (the group 50) used for the training of the super resolution and the super-resolution model 102ᵢ to be trained anew are caused to compete and learn. Therefore, it is unnecessary to label, in advance, the data set (the group 50) used for the training of the super resolution. Labeling during the training is unnecessary and clustering is possible. It is possible to efficiently perform the optimization of the super-resolution model 102ₖ and 102ᵢ.

### Other Embodiments

Note that the embodiments are not limited to the embodiments explained above. Various modifications of the embodiments are possible in a range not departing from the gist of the present invention.

In the embodiments, the example is explained in which the Web page information 20 including the image for distribution 200 is distributed from the Web server 2 via the network 3 and the image for distribution 200 is super-resolved in the terminal 1. However, a low-resolution image only has to be distributed and super-resolved in the terminal 1. It goes without saying that it is unnecessary to include the low-resolution image in the Web page information 20 and distributed. That is, the super-resolution program 111 for causing the image classifying model 101 and the super-resolution models 102₀, 102₁, . . . to operate can be combined with not only the Web browser but also any application program included in the terminal 1.

Note that the group 50 of images used for training and the image for distribution 200 may be different from each other or may be the same. When the group 50 and the image for distribution 200 are different, it is possible to create the super-resolution models 102₀, 102₁, . . . , which are general models, from the group 50. When the group 50 and the image for distribution 200 are the same, it is possible to create the super-resolution models 102₀, 102₁, . . . optimum for the image for distribution 200.

In the embodiments, the super resolution is explained as the example of the image processing. However, as other examples, the embodiments are also applicable to training about image processing such as noise removal from an image, removal of a blur, and sharpening. Content of the image processing is not particularly limited. About the image processing trained using the training method, content of the image processing is not limited to the super resolution either.

In the embodiments explained above, the functions of the models 100 to 104 of the control unit 10 are realized by the program. However, all or a part of the models may be realized by hardware such as an ASIC. The program used in the embodiments can also be stored in a recording medium such as a CD-ROM and provided. Replacement, deletion, addition, and the like of the steps explained in the embodiments are possible in a range not changing the gist of the present invention.

### Advantageous Effects of Invention

According to an aspect of embodiments, it is possible to perform the training of the image processing such that accuracy of the image processing for the classification domain of input images is improved.

According to an aspect of embodiments, it is possible to complete the training when all of the plurality of image processing models are trained or when the classification label of the training image of the classification domain having the largest number of training images of the cluster is only i-th or k-th.

According to an aspect of embodiments, it is possible to cluster, without requiring labeling in advance, the data set used for the training of the image processing.

According to an aspect of embodiments, it is possible to classify the image that is subjected to the image processing to any one of the predetermined plurality of categories, and subject the image to the image processing with the image processing model associated with the category of the classification result.

According to an aspect of embodiments, it is possible to extract the plurality of partial regions included in the image that is subjected to the image processing, calculate feature values of the plurality of partial regions in the image, and average the calculated feature values to classify the image for the image processing.

According to an aspect of embodiments, it is possible to perform image processing optimized for the image distributed by the server apparatus.

### INDUSTRIAL APPLICABILITY

There are provided an image processing learning program for clustering, without requiring labeling in advance, a data set used for learning of image processing and performing the learning of the image processing such that accuracy of the image processing for classification domains is improved, an image processing program trained by the program, and an information processing apparatus and an image processing system.

### REFERENCE SIGNS LIST

1 terminal
2 Web server
3 network
5 super-resolution system
10 control unit
11 storing unit
12 communication unit
13 display unit
14 operation unit
20 Web page information
50 group
100 Web-page-information receiving unit
101 image classifying models
102₀, 102₁ super-resolution models
103 Web-page-display control means
104 training models
110 Web browser program
111 super resolution program
112 Web page information
113 super-resolution image information
114 super-resolution learning program
130 display image
200 image for distribution

1. A non-transitory computer-readable medium having stored thereon instructions, that when executed by a processor causes the processor to:
(S-1) prepare a plurality of target images;
(S-2) prepare a plurality of training images, wherein each of the plurality of training images is prepared by lowering a resolution of a corresponding target image of the plurality of target images;
(S-3) for each of the plurality of training images, train and update a first super-resolution model by executing the following steps a) to d):
a) input a training image of the plurality of training images into the first super-resolution model and generate a higher-resolution training image,
b) compare the higher-resolution training image with a corresponding target image of the plurality of target images,
c) calculate a difference between the higher-resolution training image and the corresponding target image,
d) update the first super-resolution model through a feedback of the calculated difference;
(S-4) for each of the plurality of training images, train a second super-resolution model in a same manner as training the first super-resolution model by executing the steps a) to d) in (S-3), thereby update the second super-resolution model;
(S-5) label each of the plurality of training images based on the differences obtained from the updated first super-resolution model and the updated second super-resolution model through the step d) in (S-3), and classify each of the plurality of training images according to each label representing a preference of either the updated first super-resolution model or the updated second super-resolution model;
(S-6) using each of the plurality of training images that are clustered in a largest cluster, based on the classification of the plurality of training images, that includes a greatest number of the plurality of training images having a commonly preferred updated super-resolution model,
train a super-resolution model-K in a same manner as training the first super-resolution model by executing the steps a) to d) in (S-3), thereby update the super-resolution model-K, wherein K is an arbitrary number in a sequence;
(S-7) update the label of each of the training images of the plurality of training images in the largest cluster based on differences obtained from the updated super-resolution model-K and the commonly preferred updated super-resolution model, and re-classify the training images of the plurality of training images in the largest cluster into sub-clusters according to each of the updated label representing a preference of either the updated super-resolution model-K or the commonly preferred updated super-resolution model; and
(S-8) repeat (S-6)-(S-7) to generate sub-clusters until a predetermined condition is satisfied.

2. The non-transitory computer-readable medium according to claim 1, wherein (S-8) is repeated until either all of super-resolution models are trained, or until all clusters have a same number of training images.

3. The non-transitory computer-readable medium according to claim 1, further comprising a step of correlating each of the labeled plurality of training images with the updated first super-resolution model and the updated second super-resolution model after (S-5) and before (S-6), by inputting all of the labeled plurality of training images in each of the updated first super-resolution model and the updated second super-resolution model; and
a step of updating the correlation of each of the labeled plurality of training images with the updated super-resolution model-K and the commonly preferred updated super-resolution model after (S-7) and before (S-8), by inputting all of the labeled plurality of training images in each of the updated super-resolution model-K and the commonly preferred updated super-resolution model.

4. The non-transitory computer-readable medium according to claim 1, further comprising a step, after (S-8), of training a classification model based on all of the updated labeled plurality of training images.

5. The non-transitory computer-readable medium according to claim 4, wherein the trained classification model is configured to:
receive an image prepared for distribution;
extract a plurality of patches consisting of partial areas of the image;
calculate an output value for each of the plurality of patches;
classify the image into one of a plurality of classifications based on an average value of the output values;
select a most preferable updated super-resolution model that super-resolves the image most accurately;
super-resolve the image using the most preferable updated super-resolution model; and
save a super-resolved image in a storage unit.

6. An image processing system comprising:
a server configured to transmit an image prepared for distribution via a network, and
a terminal configured to receive the image prepared for distribution and comprising one or more processors and the non-transitory computer-readable medium according to claim 5.

7. The image processing system according to claim 6, wherein the plurality of training images in (S-2) are the image prepared for distribution.

8. A non-transitory computer-readable medium having stored thereon instructions, that when executed by a processor causes the processor to:
(S-1) prepare a plurality of target images;
(S-2) prepare a plurality of training images, wherein each of the plurality of training images is prepared by lowering a resolution of a corresponding target image of the plurality of target images;
(S-3) for each of the plurality of training images, train and update a first super-resolution model by executing the following steps a) to d):
a) input the training image in the first super-resolution model and generate a higher-resolution training image,
b) compare the higher-resolution training image with the corresponding target image of the plurality of target images,
c) calculate a difference between the higher-resolution training image and the corresponding target image,
d) update the first super-resolution model through a feedback of the calculated difference, wherein the calculated difference is recorded as resolution accuracy of the first-resolution model to the corresponding training image;
(S-4) for each of the plurality of training images, train a second super-resolution model in a same manner as training the first super-resolution model by executing the steps a) to d) in (S-3), thereby update the second super-resolution model;
(S-5) determine which one of updated super-resolution models preferably resolved a greatest number of the plurality of training images;
(S-6) using each of the plurality of training images of the greatest number of the plurality of training images resolved by the preferred updated super-resolution model, train a super-resolution model-K in a same manner as training the first super-resolution model by executing the steps a) to d) in (S-3), thereby update the super-resolution model-K, wherein K is an arbitrary number in a sequence;
(S-7) using each of all the plurality of training images, train all of the updated super-resolution models including the updated super-resolution model-K, in a same manner as training the first super-resolution model by executing the steps a) to d) in (S-3); and
(S-8) repeat (S-6)-(S-7) to update the resolution accuracy of each of the updated super-resolution models corresponding to each of the plurality of training images, until a predetermined condition is satisfied.

9. The non-transitory computer-readable medium according to claim 8, further comprising a step, after (S-8), of training a classification model based on the updated resolution accuracy of each of the updated super-resolution models.

10. The non-transitory computer-readable medium according to claim 9, wherein the trained classification model is configured to:
receive an image prepared for distribution;
extract a plurality of patches consisting of partial areas of the image;
calculate an output value for each of the plurality of patches;
classify the image into one of a plurality of classifications based on an average value of the output values;
select a most preferable updated super-resolution model that super-resolves the image most accurately,
super-resolve the image using the most preferable updated super-resolution model; and
save a super-resolved image in a storage unit.

11. An image processing system comprising:
a server configured to transmit an image prepared for distribution via a network, and
a terminal configured to receive the image prepared for distribution and comprising one or more processors and the non-transitory computer-readable medium according to claim 10.

12. The image processing system according to claim 11, wherein the plurality of training images in (S-2) are the image prepared for distribution.

13. A method for processing images comprising, by one or more computing devices:
(S-1) prepare a plurality of target images;
(S-2) prepare a plurality of training images, wherein each of the plurality of training images is prepared by lowering a resolution of a corresponding target image of the plurality of target images;
(S-3) for each of the training images, train and update a first super-resolution model by executing the following steps a) to d):
a) input the training image in the first super-resolution model and generate a higher-resolution training image,
b) compare the higher-resolution training image with a corresponding target image of the plurality of target images,
c) calculate a difference between the higher-resolution training image and the corresponding target image,
d) update the first super-resolution model through a feedback of the calculated difference,
(S-4) for each of the plurality of training images, train a second super-resolution model in a same manner as training the first super-resolution model by executing the steps a) to d) in (S-3), thereby update the second super-resolution model;
(S-5) label each of the plurality of training images based on the differences obtained from the updated first super-resolution model and the updated second super-resolution model through the step d) in (S-3), and classify each of the plurality of training images according to each label representing a preference of either the updated first super-resolution model or the updated second super-resolution model,
(S-6) using each of the plurality of training images that are clustered in a largest cluster, based on the classification of the plurality of training images, that includes a greatest number of the plurality of training images having a commonly preferred updated super-resolution model,
train a super-resolution model-K in a same manner as training the first super-resolution model by executing the steps a) to d) in (S-3), thereby update the super-resolution model-K, wherein K is an arbitrary number in a sequence;
(S-7) update the label of each of the training images of the plurality of training images in the largest cluster based on differences obtained from the updated super-resolution model-K and the commonly preferred updated super-resolution model, and re-classify the training images of the plurality of training images in the largest cluster into sub-clusters according to each of the updated label representing a preference of either the updated super-resolution model-K or the commonly preferred updated super-resolution model; and
(S-8) repeat (S-6)-(S-7) to generate sub-clusters.
